(19) United States
(12) Patent Application Publication
(10) Pub. No.: US 2011/0063575 A1
(43) Pub. Date: Mar. 17, 2011

(54) 3D Autostereoscopic Display System With Multiple Sets Of Stereoscopic Views

(76) Inventors: Bradley Nelson, Castaic, CA (US); Lowell A. Noble, Los Gatos, CA (US); Mellissa Noble Asmussen, Los Gatos, CA (US)

(21) Appl. No.: 12/818,007

(22) Filed: Jun. 17, 2010

Related U.S. Application Data
(60) Provisional application No. 61/218,198, filed on Jun. 18, 2009.

(51) Int. Cl. G02B 27/22

(52) U.S. Cl. 353/7; 359/463

(57) ABSTRACT

Multiple sets of view channels originate from multiple projected views modulated through an optic assembly comprising a Fresnel lens, a vertical dispersion lenticular lens, and a diffuser. Compact projection enclosures are formed using image-repeating mirrors to create a three-dimensional autostereoscopic viewing experience in free space without the use of special eyeglasses and without the use of view screens. Multiple sets of images are repeated within a viewing zone that may extend well beyond the confines of the enclosure and may be projected through and beyond a glass window. An observer walking past the window will see one view channel per eye, due in part to the repeated images, and due in part to the vertical dispersion of each projected view. Separate images for each view channel may be created by using two or more cameras spaced apart at a distance interval to match the average horizontal distance between the eyes of a human observer. Multiple views or multiple sets of view channels may be generated and projected.

This application claims priority, under 35 U.S.C. §119(e), to U.S. Provisional Application No. 61/218,198 filed Jun. 18, 2009, which is expressly incorporated herein by reference.

### FIELD OF THE INVENTION

The present invention generally relates to projection/display systems. More particularly, the invention relates to multiple projection views that are modulated for producing 3D autostereoscopic effects.

### BACKGROUND

Imagine strolling down the sidewalk in a metropolis, passing a window display such as a “window shopping” display attraction that a major department store would provide. Imagine that the window display attraction, instead of being lighted by ambient light, were a scene brilliantly projected into your eyes. Imagine the scene changes realistically as you stroll further past the window display. Further imagine that the scene appears in every regard to be in three dimensions, and that the perspective perceived by your eyes changes realistically as you walk past the display. Such an experience is a goal of auto-stereoscopic displays. Stereoscopic display systems attempt to recreate a real life visual experience wherein a viewer sees a different view or image in each eye and the viewer's brain is ‘tricked’ into perceiving a three-dimensional scene. In a real world viewing experience, a viewer with two eyes sees two slightly different images, as each eye is in a slightly different viewing position (separated by the distance between one's eyes). A goal of stereoscopic display systems is to present a separate, segregated and different view to each eye of the viewer, thus offering the viewer the experience of perceiving a three-dimensional scene, even though the scene is projected using only two-dimensional images. Some stereoscopic display systems require special eyeglasses to be worn by the viewer, the special eyeglasses capable of segregating (e.g. by use of separate colored lenses, or separately polarized lenses) two projected images, one for each eye.

However, it may not be convenient or possible for a viewer to wear such special eyeglasses, thus more advanced techniques for auto-stereoscopic viewing are needed. In this context, the term auto-stereoscopic (or, equivalently, autostereoscopic) refers to the ability to project a three-dimensional (3D) scene and to allow the 3D scene to be viewed in three dimensions by a viewer who is not wearing any special glasses or eyewear or headwear.

Some early attempts at implementing autostereoscopic effects without the use of a screen used two convex lenses to project a background scene and a front image. However, such techniques presented a narrow or restricted viewing area confined within an enclosure that housed the two lenses. Moreover such convex lens-based configurations failed to provide a means of providing a separate viewing channel for each eye. Also, such configurations are not well suited for viewing in large venues.

Thus, there exists a need for techniques to project autostereoscopic scenes out of and beyond the confines of a projection enclosure. Moreover, there exists a need for techniques to implement 3D autostereoscopic display systems with multiple sets of stereoscopic views such that the viewer (observer) can move (e.g. walk) in free space, yet the scene remains perceived in three dimensions.

### SUMMARY OF THE INVENTION

Methods and techniques project autostereoscopic scenes into free space viewports—out of and beyond the confines of a projection enclosure. Multiple sets of view channels originate from multiple projected views modulated through an optic assembly comprising a Fresnel lens, a vertical dispersion lenticular lens, and a diffuser. Compact projection enclosures are formed using image-repeating mirrors to create a three-dimensional autostereoscopic viewing experience in free space without the use of special eyeglasses and without the use of view screens. Multiple sets of images are repeated within a viewing zone that may extend well beyond the confines of the enclosure and may be projected through and beyond a glass window. An observer walking past the window will see one view channel per eye, due in part to the repeated images, and due in part to the vertical dispersion of each projected view. Separate images for each view channel may be created by using two or more cameras spaced apart at a distance interval to match the average horizontal distance between the eyes of a human observer. Multiple views or multiple sets of view channels may be generated and projected.

### BRIEF DESCRIPTION OF THE DRAWINGS

A brief description of the drawings follows:

FIG. 1 depicts a plan view showing one embodiment of projectors and reflecting mirrors configured as a 3D autostereoscopic display system with multiple sets of stereoscopic views, according to one embodiment.

FIG. 2A depicts a perspective view of a planar display device for projecting a series of images into a corresponding series of lenses, according to one embodiment.

FIG. 2B depicts a series of lenses positioned at a distance from a planar display device, according to one embodiment.

FIG. 3 depicts a front view facing-planar display device that is projecting multiple views from multiple different sections of the planar display device, according to one embodiment.

FIG. 4 depicts a top view of a planar display device including a depiction of multiple lenses trained at multiple sections of a planar display device, according to one embodiment.

FIG. 5 depicts a perspective view of four representations of four different views of a scene corresponding with four different views seen by an observer moving from left to right across a projected scene, according to one embodiment.

FIG. 6A depicts a top perspective view of an apparatus for a 3D autostereoscopic display system with multiple sets of stereoscopic views projected into space, according to one embodiment.

FIG. 6B depicts the horizontal orientation of the lenticules of a lenticular lens such that a vertical spreading of the projection results, according to one embodiment.

FIG. 7 depicts a top view of one embodiment of a lens maze used for repeating projections for implementing a 3D autostereoscopic display system with multiple sets of stereoscopic views, according to one embodiment.

FIG. 8 depicts a view of a horizontal linear array of cameras, according to one embodiment.

FIG. 9 depicts a top view of an array of multiple projectors pointed at an optics assembly for implementing a 3D autostereoscopic display system with multiple sets of stereoscopic views, according to one embodiment.

FIG. 10 depicts a top view of a vertically spread free floating projection, shown in relation to a standing observer, according to one embodiment.

FIG. 11 depicts a block diagram of a method for producing three-dimensional autostereoscopic displays with multiple sets of stereoscopic views.

FIG. 12 is a diagrammatic representation of a network of computers, including nodes for client computer systems, nodes for server computer systems and nodes for network infrastructure, according to one embodiment.

### DETAILED DESCRIPTION

The following detailed description is directed to certain specific embodiments of the invention. However, the invention can be embodied in a multitude of different ways as defined and covered by the claims and their equivalents. In this description, reference is made to the drawings wherein like parts are designated with like reference characters throughout.

Stereoscopic display systems may generally be divided into two categories. In the first category, two views or view channels are projected. The two view channels are then segregated after traveling to the observer by use of polarized or other special eyeglasses worn by the observer. In such embodiments in this first category, eyeglasses comprised of colored filters would segregate projections of images coded using different colors. In other embodiments in this first category, circular polarized lenses are used by observers (possibly using special polarized lens eyeglasses worn by the observer) to separate view channels projected through complementary polarized lenses. This first category of stereoscopic display systems have numerous shortfalls and are not well suited for sidewalk adverting displays where passing observers would not likely be wearing the appropriate special eyeglasses.

The second category of stereoscopic display systems is sometimes referred to as 3D autostereoscopic display systems, wherein special eyeglasses are not required to be worn by the observer. In order to better understand the principles of the invention, a discussion of various terms used herein is provided:

An “autostereoscopic” projection refers to the ability to project a 3D image to allow the 3D image to be viewed in 3D by an observer who is not wearing any special glasses or eyewear.

A “parallax barrier” refers to the use of a matrix of vertical black lines (i.e. a black line barrier) placed at a specific distance from the display. The resulting matrix segregates the views for viewing by one eye only to create a 3D effect. The parallax barrier method exhibits certain viewing characteristics. For example, in order to read text on a screen, a black line barrier may be embodied using an additional active LCD panel mounted in front of the display panel. Such a “two view system” presents a series of narrow sweet-spots where a 3D effect occurs at a specific distance from the screen. The parallax barrier system exhibits a depth-reversing effect, which effect is apparent when the observer's head moves a fraction of an inch to the left or right.

A “lenticular lens” may use a plastic or glass lens with vertically patterned or diagonally patterned lenticules formed in or adhered to the lens. In some cases, this method supports a number of views, (e.g. between five and nine views). Some lenticular lens designs exhibit a wide sweet-spot and some lookaround capability, which effects may be exhibited at a specific viewing distance.

A “holographic projection” may use a glass hologram as an optical element to replace the screen in a TV set. Two or more views are projected onto the hologram which directs the images into the observers' left and right eyes. Techniques using holograms exhibit various effects, including exhibiting a limited range of view, and color attenuation and/or color shifting depending on the viewing angle.

A “volumetric system” may use a stack of transparent LCD panels to display a three-dimensional object within the area of the panels. This technology does not produce the 3D illusion of objects appearing out of the screen or in front of the screen. While the images displayed are semi-transparent and holographic in appearance, a high bandwidth link is required to drive each of the individual panels.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

A reference in the specification to “one embodiment” or “an embodiment” means that a particular feature, structure, or characteristic described in connection with the embodiment is included in at least one embodiment of the invention. An appearance of the phrase “in one embodiment” in various places in the specification are not necessarily all referring to the same embodiment nor are separate alternative embodiments mutually exclusive of other embodiments.

In the following detailed description of embodiments of the invention, reference is made to the accompanying drawings in which like reference characters indicate similar elements, and in which is shown by way of illustration specific embodiments in which the invention may be practiced. These embodiments are described in sufficient detail to enable those skilled in the art to practice the invention, and it is to be understood that other embodiments may be used and that logical, mechanical, electrical, functional, and other changes may be made without departing from the scope of the present invention. The following detailed description is, therefore, not to be taken in a limiting sense.

The description which follows, and the embodiments described therein, are provided by way of illustration of an example, or examples of particular embodiments of the principles of the present invention. These examples are provided for the purposes of explanation, and not of limitation, of those principles of the invention. The drawings are not necessarily to scale and in some instances proportions may have been exaggerated in order to more clearly depict certain features of the invention.

### Overview

The following paragraphs present an overview of several embodiments, with further description of the embodiments presented in correspondence to the figures. The present invention advances the related art by presenting systems comprising a configuration of Fresnel lenses, lenticular lenses, diffusers, and deflecting mirrors to create two or more visual channels that may be repeated multiple times throughout a viewing area. Desired results are achieved in such combinations. Such results include, but are not limited to:

a large viewport;

the projection of an entire three-dimensional image at a distance outside of the enclosure (e.g. into free space);

the illusion of free floating, 3D images; and

the system's ability to project images without the aid of a conventional screen.

Views may be projected into free space at a distance from the enclosure. For example, views may be projected into free space at a distance of between two and ten feet. The projected distance can be varied depending on the power of the projectors and Fresnel lens used. Various embodiments as described herein use projectors to project two separate images, which projection emanates into space outside of the confines of an enclosure. In some embodiments of the present invention, the system is configured to project multiple sets of stereoscopic views, with two or more channels spaced approximately two and a half inches apart—the same distance, on center, as separate a human's eyes. In other words, embodiments are configured such that a full resolution image displayed to each eye (e.g. a left full resolution image and a right full resolution image). Of course, other image projection techniques might divide an image into a series of multiplexed views. Such a technique effectively reduces the viewed image to a lower resolution image.

Another technique seizes advantage of configurations of the optics in a manner that directly project images into the observer's eyes. This technique of direct projection produces an extremely bright image that requires relatively less power to produce and enables projected views to be repeated with multiple reflections without degrading the brightness below the brightness needed to normally view the results in well lighted or outdoor environments.

Still other embodiments make use of multiple sets of cameras aligned on an axis (e.g. a horizontal axis) to correlate with expected positions and movements of an observer such that multiple projectors project multiple views of an object, which multiple views may have been recorded (e.g. on film media or on digital media) using multiple sets of cameras to record views of a scene from different perspectives. With the media produced by multiple sets of cameras, multiple views may be projected such that an observer walking by the invention will perceive a realistic, 3D view of the recorded scene (and/or objects therein) as the observer moves from one position to the next. That is, as the observer moves from one position to the next, the observer's eyes will perceive the scene in 3D.

In various embodiments, projected views may originate from any display and/or projecting means, including but not limited to LEDs, LCDs, lasers, video monitors, and video projectors. Each view is narrowly focused using a Fresnel lens or similar convex lens. The narrow transmission of a view allows the view to be seen in free space at a distance from the lens. A Fresnel lens may be coupled with a lenticular lens to project or spread the image along the vertical axis. In some cases, this arrangement serves to further limit the horizontal spreading of the transmission. Further, a diffuser may be disposed together with the Fresnel lens and the lenticular lens, the diffuser smoothing the image such that the observer may look up and down and yet perceive a consistent image, relatively free of discontinuities.

As discovered in the reduction to practice of the present invention, the use of lenticular lenses without a contrast filter (grey coating) together with the Fresnel lens and also the diffuser produced the desired results and view-ability improvements. In some embodiments, the use of a diffuser may compensate for the contrast filter coating found on some lenticular lenses, and the use of a diffuser may even eliminate entirely the need for such a coating.

These and other objects and advantages will be made apparent when considering the following descriptions in conjunction with the figures.

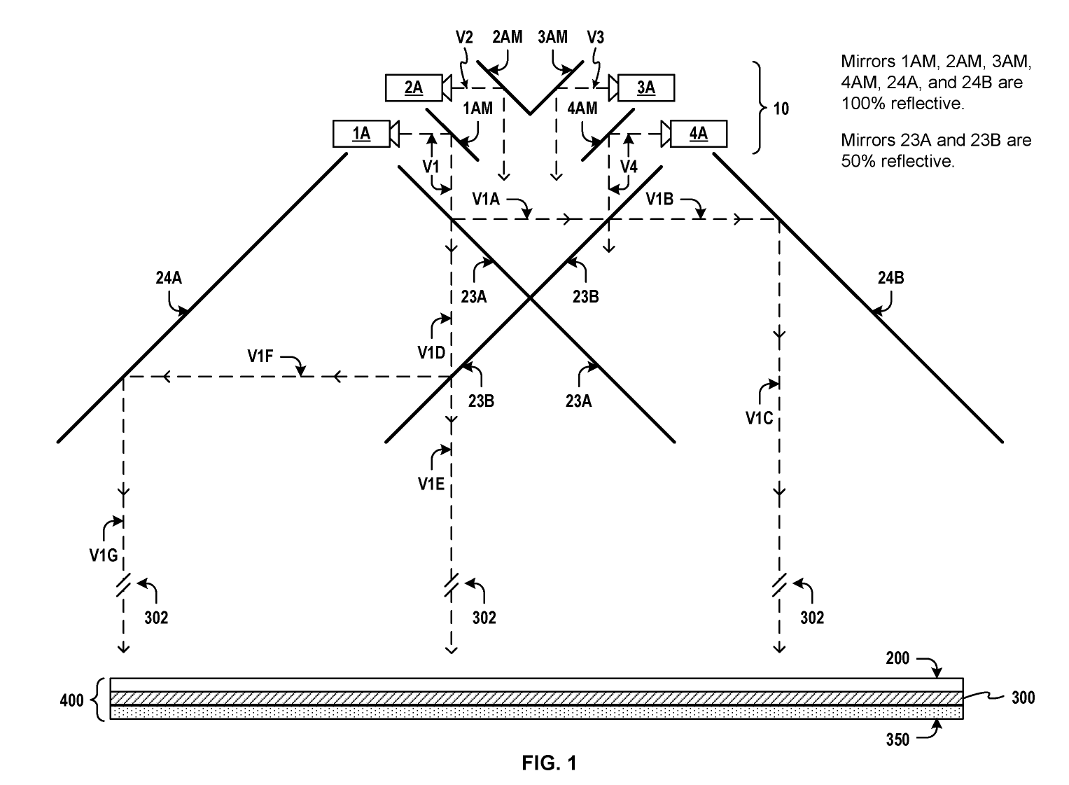

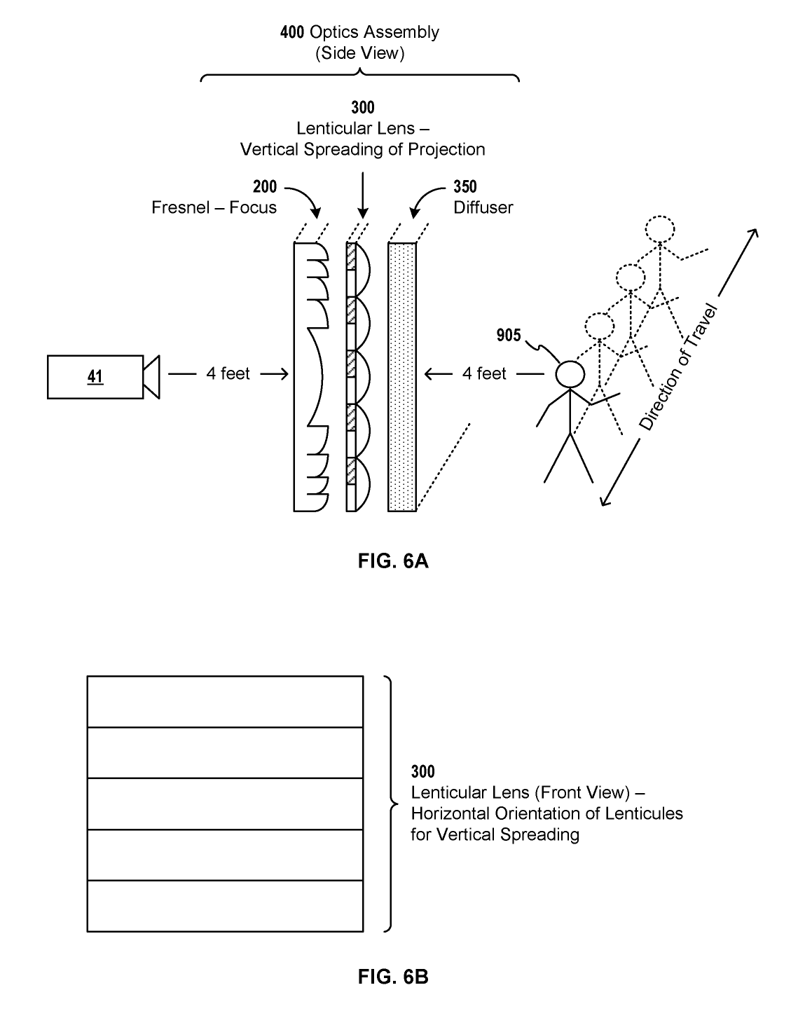

FIG. 1 depicts a plan view showing one embodiment of projectors and reflecting mirrors configured as a 3D autostereoscopic display system with multiple sets of stereoscopic views. As shown, FIG. 1 shows a mirror maze assembly 10 in an exemplary embodiment of the invention wherein four projectors project four separate views. Projectors 1A, 2A, 3A and 4A project four distinct views of a scene. Such views are labeled V1, V2, V3 and V4, and the reference characters V1, V2, V3 and V4 point generally to the area of projection of the view. Of course number of views captured or projected is not limited to the four views as shown in this embodiment of mirror maze assembly 10, and any number of views may be present in various embodiments. For example, see the embodiment as shown in FIG. 6.

A mirror maze assembly 10 using four redirection mirrors is shown in FIG. 1, however, a larger mirror maze assembly patterned after the mirror maze assembly 10 may comprise any number of projectors, and may further comprise any number of reflective mirrors to project the views produced by the projectors. In the illustrated embodiment, a first projector 1A is projecting a first view V1; a second projector 2A is projecting a second view V2; a third projector 3A is projecting a third view V3; and a fourth projector 4A is projecting a forth view V4. Each of the redirection mirrors first reflect the projected images, namely mirrors 1AM, mirror 2AM, mirror 3AM and mirror 4AM, which have 100% reflection. The configuration shown serves to allow for compact spacing of the transversely-mounted projectors. Projectors mounted such that the projection is steered perpendicularly before reaching the observer are considered transversely mounted.

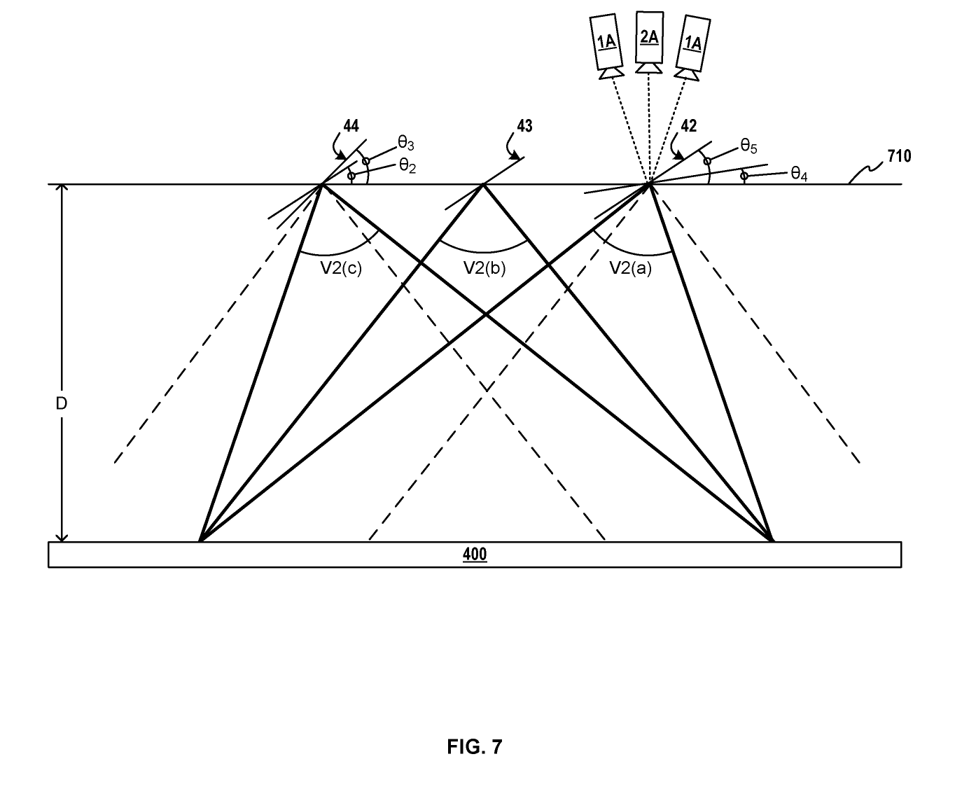

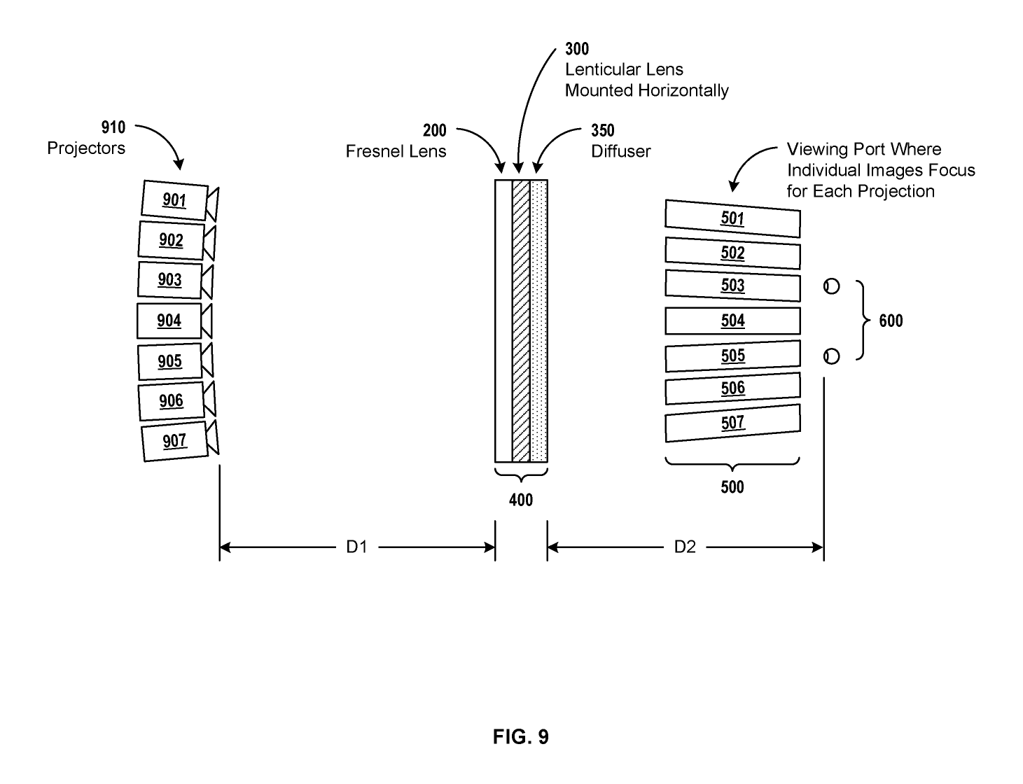

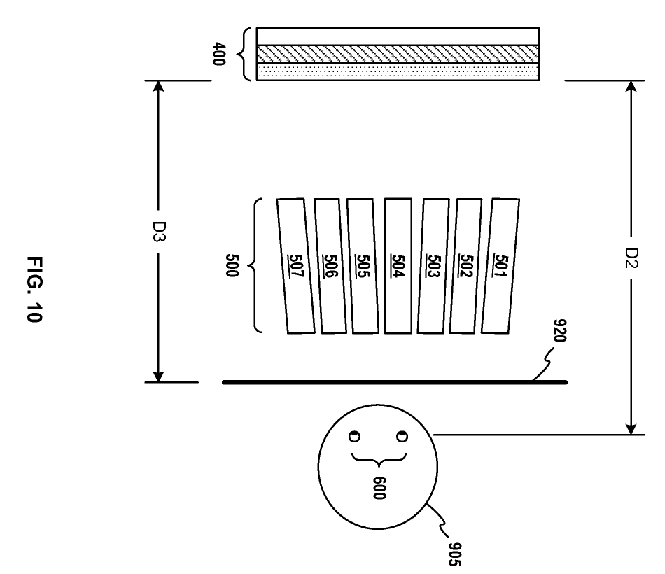

In some embodiments, the projectors may be placed facing the optics assembly 400 (see the embodiments of FIG. 9), however, in such a configuration, the overall projection assembly may not be as spatially compact as compared to the configuration as shown in the mirror maze assembly 10. That is, in the configuration of FIG. 1, the projectors are pointing inwardly (rather than toward the optics assembly 400) and use the mirror maze assembly 10 for directing the projected images toward the optics assembly 400. Additionally the entire assembly, possibly including an enclosure, can be reduced in depth by use of a large reflecting mirror placed at a 45 degree angle to the screen and locating the projectors below the screen much the same way that rear projection television reduces the depth of a TV set. An example of using 45 degree mirrors is shown in FIG. 7.

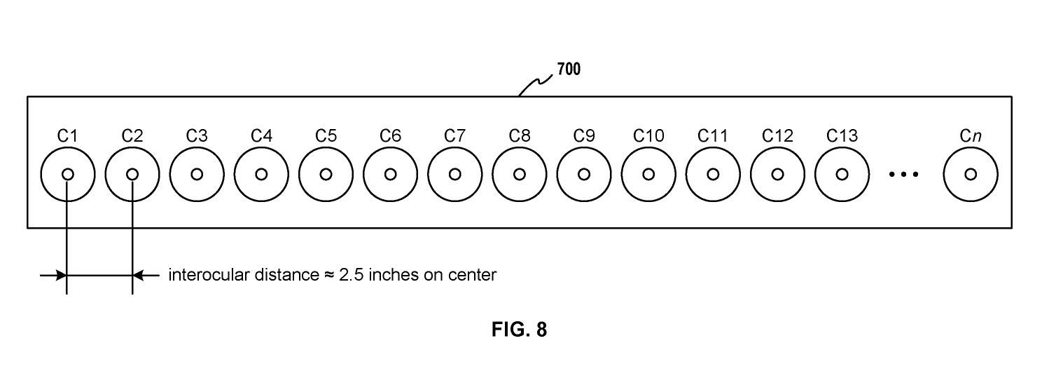

While four projectors are shown in FIG. 1, additional projectors are contemplated. Each projector projects one view of a scene. In some embodiments, the media for a given projector may be obtained from one among a plurality of cameras. For example, such a plurality of cameras may be arranged linearly as a horizontal line of cameras, such as the cameras shown in FIG. 8. In such cases, for example using the first eight cameras (e.g. C1-C8), eight scenes may be projected using eight projectors arranged in an inward-facing array similar to the projectors as shown in FIG. 1, or eight projectors may be arranged in an outward-facing array similar to the projector arrangement as shown in FIG. 9.

Returning to the description of FIG. 1, a first projector 1A projects a first view V1, and the projected image traverses through the mirror maze. The segments on the path of traversal are denoted as V1A, V1B, V1C, V1D, V1E, V1F, and V1G. As shown, the first projector 1A projects a first view V1 to redirection mirror 1AM to direct the projection of V1 through a first reflective mirror 23A. Reflective mirror 23A may have a reflective index of approximately 50%, causing 50% of the projection to strike mirror 23B, as shown by projection line V1D. The remaining 50% of light reflects from mirror 23A to a second mirror 24B. Reflective mirror 24B may have a reflective index of 100% causing projection V1C to emanate toward optics assembly 400.

Projection V1D reaches the lower section of mirror 23B wherein 50% of the signal passes through mirror 23B and reaches the optics assembly 400 as shown by view line V1E. The other 50% of V1D reflects off of mirror 23B and becomes projection V1F, which emanates toward mirror 24A and which may have an index of 100% to reflect the projection to optics assembly 400 as shown in projection line V1G.

Views V2, V3, and V4 are similarity reflected via mirrors in mirror maze assembly 10. The result is a series of views V1 through V4 being repeated along the optics assembly 400. For purposes of ease of illustration and so as not to obscure the elements of the figure, only the projections of a first view V1 is shown in FIG. 1. Nonetheless, as can be seen, given the views V1, V2, V3, and V4, the mirror maze serves for reflecting the corresponding plurality of views (e.g. V1, V2, V3, and V4) using a plurality of mirrors (e.g. mirrors 1AM, mirror 2AM, mirror 3AM and mirror 4AM) for repeating a corresponding view.

As shown in FIG. 1, the optics assembly 400 comprises a Fresnel lens 200, a lenticular lens 300, and a diffuser 350. In embodiments of the optics assembly 400 the Fresnel lens 200 may provide a mechanically stable base to which a lenticular lens 300 is mounted, and further, the a lenticular lens 300 may provide a mechanically stable base to which a diffuser 350 is mounted.

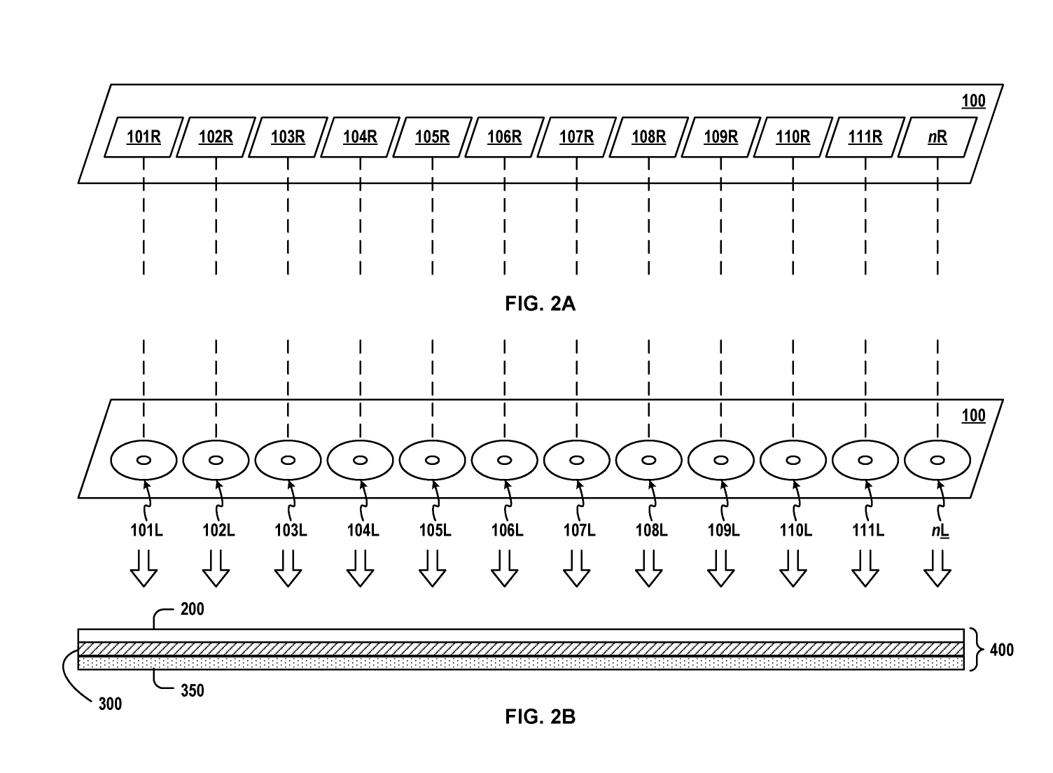

FIG. 2A depicts a perspective view of a planar display device for projecting a series of images into a corresponding series of lenses. The planar display device 100 (e.g. LCD or plasma screen) is divided into a series of regions 101R-nR. As shown the area of planar display device 100 is divided into 12 regions, however the area of planar display device 100 may be divided into more or fewer regions.

FIG. 2B depicts a series of lenses, 101L-nL positioned at a distance from planar display device 100. More particularly, the series of lenses, 101L-nL are positioned in relatively the same array as are the aforementioned series of regions 101R-nR.

This configuration for capturing source images allows multiple views to be projected with one optics assembly 400 (discussed below). As shown the image series trained by the series of lenses, 101L-nL are projected onto/through an optics assembly 400. As shown, the size of planar display device 100 is relatively the same size as the optics assembly 400, however, configurations of the apparatus of FIG. 2B may include a planar display device 100 that is relatively the larger or smaller than the optics assembly 400.

In an ideal configuration, the distance D1 between the optics assembly 400 to the projector(s), and the distance D2 between the optics assembly 400 and the eyes of the observer will be equal, as shown in FIG. 6, and in FIG. 9.

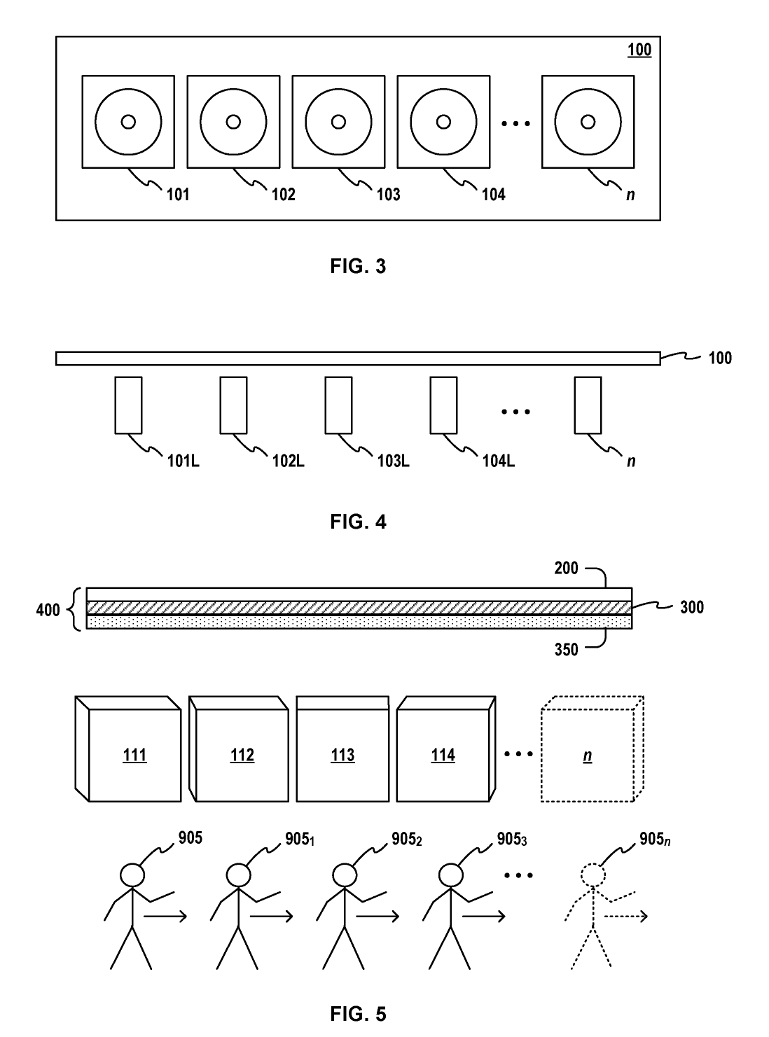

FIG. 3 depicts a front view-facing planar display device 100 that is projecting multiple views from multiple different sections of the planar display device. As shown, FIG. 3 depicts planar display device 100 having multiple screen areas or views, namely screen area 101, screen area 102, screen area 103, and screen area 104, with four lenses juxtaposed nearby. As shown, the lenses are depicted as circles shown within squares, where the squares represent separate views that are focused and transmitted by lenses (using any one of many possible transmission techniques, not shown). As earlier indicated, the planar display device 100 may be an LCD display, a plasma display, and/or may encompass other types of display technology.

FIG. 4 depicts a top view of a planar display device 100 including a depiction of multiple lenses trained at multiple sections of a planar display device. As shown. FIG. 4 depicts a planar display device 100 having multiple lenses 101L, 102L, 103L, and 104L juxtaposed at a relatively short distance from the planar display device 100.

FIG. 5 depicts a perspective view of four representations of four different views of a scene corresponding with four different views seen by an observer moving from left to right across a projected scene. As shown, FIG. 5 shows four perspective views of a cube, namely cube view 111, cube view 112, cube view 113, and cube view 114, arranged in a sequence in order to illustrate the views as would be perceived by an observer 905 walking past a stationary cube in a scene.

Now, relating to the four views perceived by observer 905 as (for example) positions 905₁, 905₂, and 905₃, the four lenses 101L, 102L, 103L, and 104L might be aligned with regions 101, 102, 103, and 104 for focusing on images corresponding to the four perspective views 111, 112, 113, and 114 of FIG. 5. Following the embodiment of FIG. 5, the four lenses 101L, 102L, 103L, and 104L of FIG. 4 (though not repeated in FIG. 5) collectively project four different views of the same object, namely perspective views 111, 112, 113, and 114 (each lens projecting one of the four views). Shown in FIG. 5 is the optics assembly 400, situated between the observer 905 and the lenses 101L, 102L, 103L, and 104L). As depicted, the array of perspective views 111, 112, 113, and 114 is relatively the same size as the optics assembly 400, however, configurations of the apparatus shown may include a larger or smaller optics assembly 400.

In this embodiment, the views may be considered single views placed adjacent to one another. Or the views may be considered four congruent views, captured using four lenses spaced a distance apart. In this embodiment, there is no specific requirement for the cameras to be spaced apart at a distance to mimic the distance between the eyes of a human. Rather, the free floating nature of each view passing through a disclosed optics assembly 400 (not shown) provides an observer experience that mimics a holographic view using multiple perspective views.

FIG. 6A depicts a top perspective view of an apparatus for a 3D autostereoscopic display system with multiple sets of stereoscopic views projected into space. As shown, a projector 41 of any type is spaced a distance (e.g. four feet) from a Fresnel lens 200 placed next to a lenticular lens 300, which in turn is placed next to a diffuser 350. The projector 41 shown is a simple representation of the multiple projected images shown in FIG. 1, FIG. 2, FIG. 3, and FIG. 4. The expected directions of travel by the observer while viewing stereoscopic views projected into space is shown.

FIG. 6B depicts the horizontal orientation of the longitudinal lenticules of a lenticular lens 300 such that a vertical spreading of the projection results. That is, the lenticules are oriented such that a portion of a projected image incident on a longitudinal lenticule results in a vertical spreading of the incident projection; thus, an observer 905 sees the projection while looking up and down. The disclosed combination of lenses, lens position, lenticule orientation, and diffuser exhibits the desired result of projecting a very narrow horizontal view. In fact, and advancing the art from earlier systems, the observer sees the projection while looking up and down and, in such embodiments, the observer may look up and down (and still perceive the projection) while moving horizontally through the multiple sets of stereoscopic views projected into space.

It should also be noted that the disclosed embodiments of a 3D autostereoscopic display system with multiple sets of stereoscopic views projects an image without using a screen. That is, the image is projected through the optics assembly directly into the eyes of the observer.

Returning to the discussion of FIG. 6A, and as can now be understood, multiple views may be placed side by side. For purposes of clarity of illustration, the embodiment of FIG. 6A depicts only a single projector 41, however in preferred embodiments, multiple views may be repeated and alternated by use of a mirror maze assembly 10 as shown in FIG. 1, or by use of multiple projectors as shown in FIG. 7 (discussed below), or as shown in FIG. 9 (discussed below). It should be noted that the minimum number of projectors or projected images for a stereo image is two.

A result of using an equal distance between the projector 41 and optics assembly 400, and the distance between the optics assembly 400 and observer bounds of a free floating viewport area (e.g. location of an observer's eyes) is the creation of a “virtual image” wherein objects are perceived by an observer to float in space. In preferred embodiments—such as for a display attraction placed aside a pedestrian walkway—the projected images may be of life-like size and have a depth of field equal to the distance between the projector 41 and the optics assembly 400. Any number of projectors may be added to create additional free floating viewports. For example, the depiction of FIG. 1 shows four projectors. As another example, the depiction of FIG. 7 shows three projectors. In yet other embodiments, in particular, configurations with multiple viewports that are non repeating (e.g. eight viewports created by eight projectors), each viewport will preferably be captured using a horizontal set of cameras separated by a human eye separation distance (i.e. interocular distance) of approximately 2.5 inches. In some embodiments, viewports may be repeated with mirrors, and in such regeneration, the viewports may be slightly stretched. In order to compensate for possible distortions from repeating viewports with mirrors, the use of a narrow eyeball/camera band is used (and is shown in FIG. 9). In an alternative embodiment, antiglare material may be placed between the Fresnel lens and lenticular lens (not shown).

FIG. 7 depicts a top view of one embodiment of a lens maze used for repeating projections for implementing a 3D autostereoscopic display system with multiple sets of stereoscopic views. The display system is shown with a three-projector, three-mirror configuration. The configuration as shown in FIG. 7 differs from the configuration shown in FIG. 1 in at least the aspect that the configuration of FIG. 7 supports three projectors 1A, 2A, and 3A, and each are pointed toward the same first mirror 42, placed at approximately a 45 degree angle to a reflection plane 710 (e.g. θ₅=45 degrees). In FIG. 7 three mirrors are shown, the first mirror 42 has a reflective index of 70%, the second mirror 43 has a reflective index of 50%, and the third mirror 44 has a reflective index of 100%.

Views V2(a), V2(b), and V2(c) become progressively wider as the view is projected into space and as the distance increases from the projectors. If mirror 42 is toed-in (i.e. toward the center) slightly (e.g. θ₅ is slightly less than 45 degrees), and similarly if mirror 44 is toed-in (i.e. toward the center) slightly (e.g. θ₃ is slightly greater than 45 degrees), then the projected images will overlap at some particular distance D from reflection plane 710. More generally, the apparatus of FIG. 7 may be reconfigured for reflecting the corresponding plurality of images using any number of toed-in mirrors. Although the embodiment of FIG. 7 shows three projectors and three mirrors, it is reasonable and envisioned that other embodiments may be arranged with five, or seven or more projectors and five or seven or more mirrors. In some embodiments, an optics assembly 400 is placed at distance D and parallel to reflection plane 710. The distance D and other distances desired or inherent in other embodiments (e.g. distance D1, distance D2, etc) are discussed below.

FIG. 8 depicts a view of a horizontal linear array of cameras. As shown, FIG. 8 depicts a number of cameras C1 through Cn positioned approximately 2.5 inches on center. Such an array of cameras may be used to capture accurate perspective views of three-dimensional objects in a scene.

FIG. 9 depicts a top view of an array of multiple projectors pointed at an optics assembly for implementing a 3D autostereoscopic display system with multiple sets of stereoscopic views. As shown, the array of projectors 910 are trained at the optics assembly 400, resulting in a human viewing experience characterized by free floating perspective images. More specifically, the configuration of FIG. 9 presents a top view, looking down upon an array of projectors 910, comprising projectors 901 through 907, the projectors collectively projecting a series of scenes into the optics assembly 400. Also shown is a free floating viewport 500 comprising projections 501 through 507, arranged in autostereoscopic pairs of projections {501, 503}, {502, 504}, {503, 505}, {504, 506}, and {505, 507}, any of which autostereoscopic pairs of projections are separated by an interocular distance of approximately 2.5 inches. Specifically shown are a pair of view eyes 600 oriented in line with autostereoscopic pair {503, 505}. In this embodiment, the view eyes 600 are positioned at a distance D2 from the optics assembly 400, which distance D2 is approximately equal to distance D1 between the optics assembly 400 to the line of projectors.

From this apparatus construction, it can be seen that the apparatus supports a method of creating viewing areas (e.g. viewports at a distance of approximately D2 from the optic assembly 400) wherein different views of scenes are presented to an observer as the observer moves from one viewport to another. Such a method might include steps comprising: recording two or more views of a scene, using one camera per scene, projecting the two or more views of a scene with two or more separate projectors, projecting the two or more views of a scene onto a Fresnel lens combined with a horizontally-oriented lenticular lens and a diffuser, and projecting the two or more views of a scene simultaneously in an order consistent with the order that the images would be viewed by an observer walking past the actual scenes.

FIG. 10 depicts a top view of a vertically spread free floating projection, shown in relation to a standing observer. As earlier described, use of the horizontally oriented lenticules effects the vertical stretching of a view, thus creating a large free floating viewport 500 such that an observer 905 (depicted from top view) may view several projected views while looking up and/or down. Also, FIG. 10 shows a plane 920 (e.g. a window) placed at a distance D3 (e.g. to a window) such that the distance D2 (e.g. to the observer's eyes) is approximately equal to the distance D1 between the projector and the optics assembly. That is, the distance D1 between the projector and the optics assembly designed to be nearly equal to the distance D2 from the optics assembly and the intended areas of viewing (e.g. to the observer's eyes 920). Further, the horizontally oriented lenticules serve to vertically spread the view projections and to keep the projections from crossing over to one another.

### Method-Oriented Embodiments

The foregoing figures and descriptions emphasize various configurations of various apparatus. Of course there are a large number of configurations of components of the apparatus, any of which might implement a method for a 3D autostereoscopic display system with multiple sets of stereoscopic views. Accordingly, the characteristics of some exemplary methods are described below.

Of course, the any of the methods described herein might be practiced by a human by virtue of manual configuration of one or more of the described apparatus-oriented embodiments of the invention, however it is reasonable and envisioned that configuration of one or more of the described apparatus-oriented embodiments of the invention might be performed by a computer, either entirely under computer control (e.g. using servos for making mechanical and distance adjustments), or in a computer-aided manner (e.g. using servos for making mechanical and distance adjustments together with human feedback). Accordingly, embodiments of the invention might come in the form of a tangible computer-readable medium, having instructions stored in a non-transitory form for execution by the aforementioned computer. Moreover, such a computer might exist as a single CPU computer, or it might exist as multiple CPUs (e.g. in a client-server configuration) arranged on a bus, or within a network for facilitating communication between the CPUs.

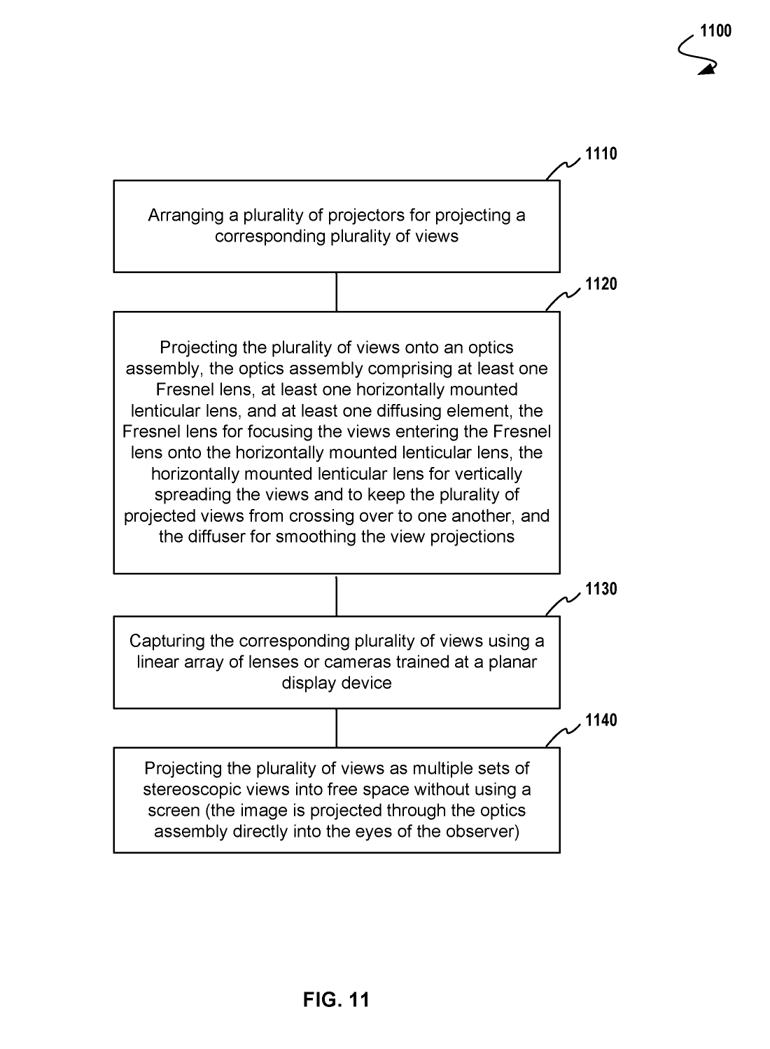

FIG. 11 depicts a block diagram of a method for producing three-dimensional autostereoscopic displays with multiple sets of stereoscopic views. As an option, the present method 1100 may be implemented in the context of the architecture and functionality of the embodiments described herein. Of course, however, the method 1100 or any operation therein may be carried out in any desired environment. The operations of the method can, individually or in combination, perform method steps within method 1100. Any method steps performed within method 1100 may be performed in any order unless as may be specified in the claims. As shown, method 1100 implements a method for producing three-dimensional autostereoscopic displays with multiple sets of stereoscopic views, the method 1100 comprising operations for: arranging a plurality of projectors for projecting a corresponding plurality of views (see operation 1110); and projecting the plurality of views onto an optics assembly, the optics assembly comprising at least one Fresnel lens, at least one horizontally mounted lenticular lens, and at least one diffusing element, the Fresnel lens for focusing the views entering the Fresnel lens onto the horizontally mounted lenticular lens, the horizontally mounted lenticular lens for vertically spreading the views and to keep the plurality of projected views from crossing over to one another, and the diffuser for smoothing the view projections (see operation 1120).

In many cases, the projected scene would have been captured using a linear array of cameras trained at a planar display device such that different views of the projected scene are presented to an observer as the observer moves from one viewport to another (see operation 1130).

Of course, after the projection has passed through the optics assembly, then projecting the plurality of views as multiple sets of stereoscopic views into free space without using a screen; no screen is needed as the image is projected through the optics assembly directly into the eyes of the observer (see operation 1140).

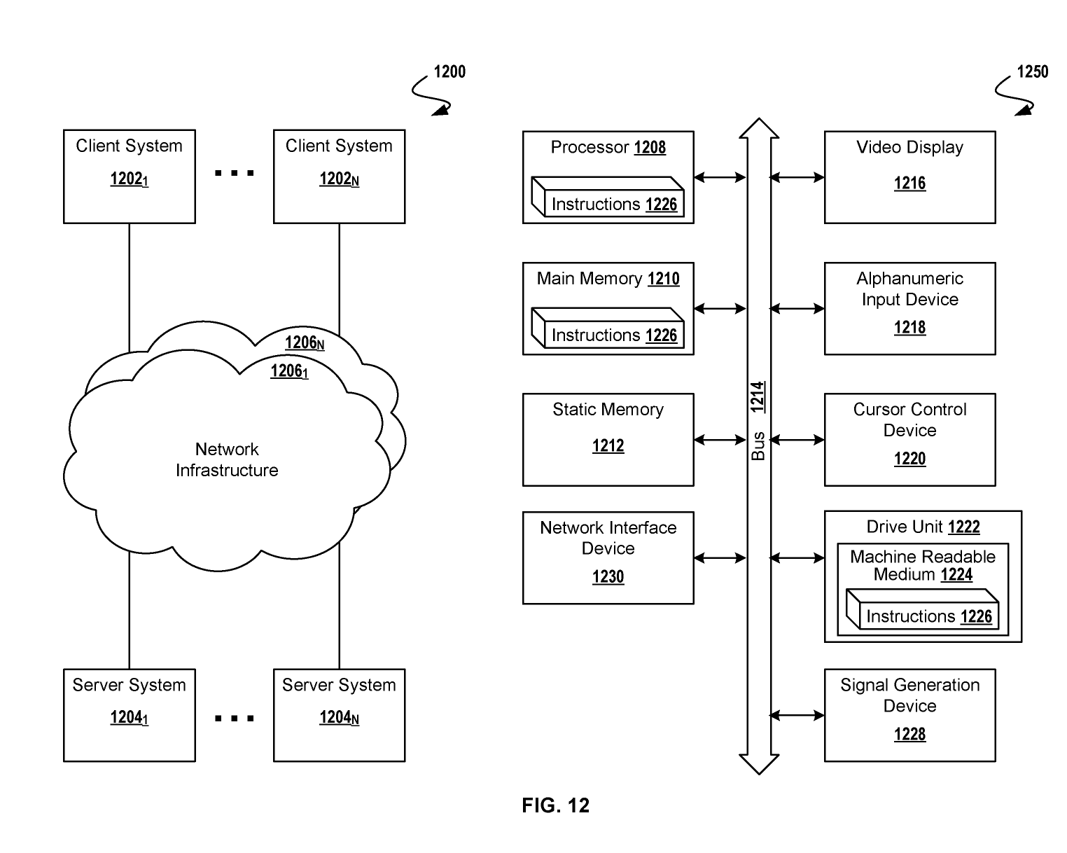

FIG. 12 is a diagrammatic representation of a network 1200, including nodes for client computer systems 1202₁ through 1202_{N}, nodes for server computer systems 1204₁ through 1204_{N}, nodes for network infrastructure 1206₁ through 1206_{N}, any of which nodes may comprise a machine 1250 within which a set of instructions for causing the machine to perform any one of the techniques discussed above may be executed. The embodiment shown is purely exemplary, and might be implemented in the context of one or more of the figures herein.

Any node of the network 1200 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1250 includes a processor 1208 (e.g. a processor core, a microprocessor, a computing device, etc), a main memory 1210 and a static memory 1212, which communicate with each other via a bus 1214. The machine 1250 may further include a display unit 1216 that may comprise a touch-screen, or a liquid crystal display (LCD), or a light emitting diode (LED) display, or a cathode ray tube (CRT). As shown, the computer system 1250 also includes a human input/output (I/O) device 1218 (e.g. a keyboard, an alphanumeric keypad, etc), a pointing device 1220 (e.g. a mouse, a touch screen, etc), a drive unit 1222 (e.g. a disk drive unit, a CD/DVD drive, a tangible computer readable removable media drive, an SSD storage device, etc), a signal generation device 1228 (e.g. a speaker, an audio output, etc), and a network interface device 1230 (e.g. an Ethernet interface, a wired network interface, a wireless network interface, a propagated signal interface, etc).

The drive unit 1222 includes a machine-readable medium 1224 on which is stored a set of instructions (i.e. software, firmware, middleware, etc) 1226 embodying any one, or all, of the methodologies described above. The set of instructions 1226 is also shown to reside, completely or at least partially, within the main memory 1210 and/or within the processor 1208. The set of instructions 1226 may further be transmitted or received via the network interface device 1230 over the network bus 1214.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

Thus, it is reasonable and envisioned that embodiments of the present invention may be delivered as a non-transitory computer readable medium (e.g. a CDROM) comprising a set of instructions which, when executed by a computer, cause the computer to configure a 3D autostereoscopic display system capable of projecting multiple sets of stereoscopic views.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A method for producing three-dimensional autostereoscopic displays with multiple sets of stereoscopic views comprising:
arranging a plurality of projectors for projecting a corresponding plurality of views; and
projecting the plurality of views onto an optics assembly, the optics assembly comprising at least one Fresnel lens, at least one horizontally mounted lenticular lens, and at least one diffusing element, the Fresnel lens for focusing the views entering the Fresnel lens onto the horizontally mounted lenticular lens, the horizontally mounted lenticular lens for vertically spreading the views and to keep the plurality of projected views from crossing over to one another, and the diffuser for smoothing the view projections.

2. The method of claim 1, further comprising capturing the corresponding plurality of views using a linear array of lenses trained at a planar display device.

3. The method of claim 1, further comprising reflecting the corresponding plurality of views using a plurality of mirrors, and having at least one transversely-mounted projector.

4. The method of claim 1, further comprising reflecting the corresponding plurality of views using a plurality of mirrors for repeating a view.

5. The method of claim 4, wherein reflecting the corresponding plurality of views comprises at least one toed-in mirror.

6. The method of claim 1, wherein the projecting the plurality of views onto an optics assembly comprises a mirror maze assembly using redirection mirrors.

7. The method of claim 1, wherein the arranging a plurality of projectors comprises using an approximate equal distance between the projector and the optics assembly as compared to the distance from the optics assembly and the intended areas of viewing.

8. An apparatus for producing three-dimensional autostereoscopic displays with multiple sets of stereoscopic views comprising:
a plurality of projectors for projecting a corresponding plurality of views; and
an optics assembly, the optics assembly comprising at least one Fresnel lens, at least one lenticular lens, and at least one diffusing element.

9. The apparatus of claim 8, further comprising a linear array of lenses for capturing the corresponding plurality of views using a planar display device.

10. The apparatus of claim 8, further comprising;
a plurality of mirrors for reflecting the corresponding plurality of views; and
wherein at least one of the plurality of projectors is a transversely-mounted projector.

11. The apparatus of claim 8, further comprising one or more mirrors for repeating the corresponding plurality of views.

12. The apparatus of claim 8, wherein the optics assembly comprises:
a Fresnel lens, for focusing the stereoscopic views entering the Fresnel lens onto a horizontally mounted lenticular lens;
a lenticular lens to vertically spread the stereoscopic view projections and to keep the projections from crossing over to one another; and
a diffuser for smoothing the stereoscopic views.

13. The apparatus of claim 8, wherein the distance between the projector and the optics assembly as compared to the distance from the optics assembly and the intended areas of viewing are approximately the same distance.

14. The apparatus of claim 8, further comprising a mirror maze assembly using redirection mirrors.

15. A method for creating viewing areas wherein different views of scenes are presented to an observer as the observer moves from one viewport to another, the method comprising:
recording two or more views of a scene, using one camera per scene;
projecting the two or more views of a scene with two or more separate projectors;
projecting the two or more views of a scene onto a Fresnel lens combined with a horizontally oriented lenticular lens and a diffuser; and
projecting the two or more views of a scene simultaneously in an order consistent with the order that the images would be viewed by an observer walking past the actual scenes.

16. The method of claim 15, wherein the recording two or more views of a scene comprises two or more lenses juxtaposed over a planar display device.

17. The method of claim 15, wherein the recording two or more views of a scene comprises a linear array of cameras for capturing the corresponding plurality of views using a planar display device.

18. The method of claim 15, wherein projecting the two or more views of a scene simultaneously comprises a mirror maze assembly using redirection mirrors.

19. The method of claim 15, further comprising reflecting the views using a plurality of mirrors for repeating a view.

20. The method of claim 19, wherein reflecting the views comprises at least one toed-in mirror.
